(19) United States
(12) Patent Application Publication
(10) Pub. No.: US 2025/0150003 A1
(43) Pub. Date: May 8, 2025

(54) BRIDGE CIRCUIT AND ENERGY CONVERSION SYSTEM

(71) Applicant: SMA Solar Technology AG, Niestetal (DE)

(72) Inventor: Klaus Rigbers, Göttingen (DE)

(21) Appl. No.: 19/013,406

(22) Filed: Jan. 8, 2025

Related U.S. Application Data
(63) Continuation of application No. PCT/EP2023/069389, filed on Jul. 12, 2023.

(30) Foreign Application Priority Data
Jul. 22, 2022 (DE) 10 2022 118 457.9

(51) Int. Cl. H02M 7/5387; H02M 1/00; H02M 7/487

(52) U.S. Cl. CPC H02M 7/53871; H02M 1/0064; H02M 7/487

(57) ABSTRACT

The disclosure relates to a bridge circuit for providing an alternating current at a phase terminal, having first and second direct current terminals for connecting to a direct current source or load. The bridge circuit includes an intermediate circuit, and a bridge with bridge switches. The bridge receives potentials at the direct current terminals and outputs potentials at first and second bridge outputs and a second bridge output which are clocked independently of one another based thereon. First and second connection paths extend between the respective bridge outputs and the phase terminal, wherein each of the connection paths comprises a filter choke. A disconnector with a plurality of relay contacts is arranged between the bridge outputs and the phase terminal. The disclosure relates to an energy conversion system with such a bridge circuit.

### REFERENCE TO RELATED APPLICATIONS

This application is a Continuation of International Application number PCT/EP2023/069389, filed on Jul. 12, 2023, which claims the benefit of German Application number 10 2022 118 457.9, filed on Jul. 22, 2022. The contents of the above-referenced patent applications are hereby incorporated by reference in their entirety.

### FIELD

The disclosure relates to a bridge circuit for providing an alternating current at a phase terminal, and to an energy conversion system with such a bridge circuit.

### BACKGROUND

When converting direct current into alternating current, or alternating current into direct current, bridge modules are used in which the voltage potentials present at the direct current terminals of the bridge modules are provided by semiconductor switches in a clocked manner at a phase terminal of the bridge modules. In this case, it is desirable to be able to provide, in addition to the positive and negative potentials of the direct current connections, additional intermediate potentials which can be formed, for example, by a divided intermediate circuit at the direct voltage connections. However, it is also known to generate intermediate potentials within the bridge module, for example, by means of a so-called “flying capacitor” topology. The more intermediate potentials that can be provided at the output terminal of the bridge module, the smaller, lighter, and thus more cost-effective a filter connected downstream of the bridge module can be.

Document DE 10 2012 107 122 A1 discloses a bridge circuit for providing an alternating current at a phase terminal, wherein additional intermediate potentials can be generated via a filter connected downstream of the bridge module in that the bridge module comprises two bridge outputs clocked offset from one another, and the filter comprises, in respective connection paths, two magnetically coupled filter chokes via which the two bridge outputs are connected to the common phase terminal. In this way, inverters with a high power density and low weight, which is largely determined by the weight of the filter, can be produced. Comparable topologies with filter chokes in separate connection paths between several bridge outputs and a common phase output are also disclosed in the documents DE 10 2016 222 001 A1 and EP 2 136 465 A1, wherein the filter chokes are not magnetically coupled.

The problem here is that, with large inverter or rectifier outputs, the currents provided by the bridge module are high and that a disconnector, which is required by safety regulations and which cuts off the current flow from the bridge module via two independently operable relay contacts, must be designed for the maximum flowing current. This leads to considerable costs and a high additional weight, since large relays are disproportionately heavy compared to small relays.

### SUMMARY

The disclosure is directed to a bridge circuit for providing or receiving an alternating current at a phase terminal or an energy conversion system with reduced material expenditure.

A bridge circuit according to the disclosure serves to provide an alternating current at a phase terminal and comprises:
a first direct current terminal and a second direct current terminal for connecting a direct current source or direct current load,
an intermediate circuit coupled across the first and second direct current terminals,
a bridge with bridge switches, which bridge is configured to receive voltage potentials at the first direct current terminal and the second direct current terminal and generate voltage potentials based thereon at a first bridge output and a second bridge output which are clocked independently of one another,
wherein a first connection path extends between the first bridge output and the phase terminal, and a second connection path extends between the second bridge output and the phase terminal,
wherein each of the first and second connection paths comprise, on the bridge output side, a filter choke, and the filter chokes of the first and second connection paths are magnetically coupled to one another,
wherein a disconnector device with a plurality of relay contacts is arranged between the bridge outputs and the phase terminal in such a manner that at least one of the relay contacts is arranged in a separated portion of each of the connection paths.

The clocking of the bridge circuit is offset with a phase shift of the carriers of the two bridge outputs, typically of half or a quarter of the switching period. This makes it possible to provide at the phase terminal, in addition to the voltage potentials of the bridge outputs, further voltage potentials the value of which lies between the actual values of the bridge output potentials. As a result, the bridge circuit can be operated with lower losses, and/or a line filter of the bridge circuit can be designed more cost-effectively.

In one embodiment, the bridge is configured to provide, at each of the bridge outputs, in addition to the voltage potentials present at the first and second direct current terminals, a third voltage potential level formed from voltage potentials of the direct current terminals. The third voltage potential can be formed by a divided intermediate circuit and tapped at a center point of this divided intermediate circuit. However, it is also conceivable to use a capacitor arranged between bridge switches of the bridge, a so-called flying capacitor, which can be used to shift the voltage of the potential present at one of the bridge outputs with respect to one of the voltage potentials of the direct current terminals. Likewise, further voltage potential levels can be formed by a multiple divided intermediate circuit or a combination of a divided intermediate circuit with a flying capacitor bridge formed and provided at the bridge outputs by suitable clocking of the bridge switches. For example, in one embodiment, the bridge may be configured to provide at each of the bridge outputs five potential levels formed from potentials of the direct current terminals.

Because the current is distributed substantially evenly between the first and second connection paths during operation of the bridge circuit, using a known balancing control for the bridge current, the current load on the relay contacts of the disconnector device is halved, so that more cost-effective and lighter relay types can be used as disconnectors. In one embodiment, the distributed relay contacts of the disconnector are located in different relay housings, so that each relay contact can be better cooled, which further reduces the required installation space. The additional costs and the additional weight due to the additional voltage measurements at the capacitors 16a and 16b and possibly 46a and 46b are negligible in comparison.

If there is a galvanic isolation plane on the DC side or AC side of the bridge circuit, e.g., formed by a transformer, no further relay contacts are required. Otherwise, safety standards require that two independently actuatable relay contacts of the disconnector be arranged in series between each of the bridge outputs and the phase terminal. In one embodiment, two relay contacts are arranged in the separated portion of the first and second connection paths. This means that in one embodiment each relay contact is designed for the maximum current flowing in the respective connection path. An application example for a bridge circuit without two serial relay contacts is a DC charging device for electric vehicles, where such a galvanic isolation plane is usually present.

In a further embodiment, the first and second connections paths have a separate portion and a common portion, and a common relay contact of the disconnector device is arranged in the common portion of the first connection path and of the second connection path. Although this means that this common relay contact is loaded with the entire phase current, it is also possible to measure an electrical variable, such as a voltage or a current, at a point between the serial relay contacts of the two connection paths using a common measuring device in the common portion of the first connection path and of the second connection path, even if both connection paths are cut off from the phase terminal by an open relay contact.

Alternatively or additionally, a further filter comprising a further filter choke and a further filter capacitor can be arranged in the common portion of the first connection path and of the second connection path, wherein a relay contact of the disconnector is arranged between the further filter and the phase terminal.

In order to effectively suppress the non-mains frequency components of the alternating current provided, a filter capacitor is, in one embodiment, connected in each of the connection paths between the filter choke and the disconnector, which filter capacitor is connected by a further terminal to the first direct current terminal, the second direct current terminal, or the center point. A connection to the center point has the advantage of a lower voltage load on the filter capacitors.

Further suppression of the non-mains frequency components of the alternating current provided or received can be achieved by arranging in at least one of the first and second connection paths, or in both connection paths, a second filter, comprising a second filter choke and a second filter capacitor, between the filter choke and the disconnector. This results in a so-called LCLC filter.

The direct current source or direct current load can also be connected via additional power electronic converters, which, for example, increase or decrease the DC voltage.

In a further embodiment of the disclosure, an energy conversion system comprises a bridge circuit according to the disclosure. The energy conversion system can be connected to an AC voltage grid in a single-phase or multi-phase manner. In the case of a multi-phase connection, a bridge circuit according to the disclosure can be provided for each of the phases. The energy conversion system, in one embodiment, comprises a photovoltaic generator or a battery as a direct current source for providing the converted alternating current. However, the energy conversion system can also have a direct current load in addition to or instead of a direct current source, or be designed to connect such a load. For example, the energy conversion system can be a DC charging device for an electric vehicle.

### BRIEF DESCRIPTION OF THE FIGURES

The disclosure is illustrated below with reference to the figures, in which:

FIG. 1 shows a first embodiment of a bridge circuit according to the disclosure,

FIG. 2 shows a second embodiment of a bridge circuit according to the disclosure,

FIG. 3 shows a third embodiment of a bridge circuit according to the disclosure,

FIG. 4 shows a fourth embodiment of a bridge circuit according to the disclosure,

FIG. 5 shows a fifth embodiment of a bridge circuit according to the disclosure,

FIG. 6 shows an embodiment of an energy conversion system according to the disclosure,

FIG. 7a shows a first embodiment of a bridge in a bridge circuit according to the disclosure,

FIG. 7b shows a second embodiment of a bridge in a bridge circuit according to the disclosure,

FIG. 7c shows a third embodiment of a bridge in a bridge circuit according to the disclosure

FIG. 7d shows a fourth embodiment of a bridge in a bridge circuit according to the disclosure,

FIG. 7e shows a fifth embodiment of a bridge in a bridge circuit according to the disclosure,

FIG. 7f shows a sixth embodiment of a bridge in a bridge circuit according to the disclosure,

FIG. 7g shows a seventh embodiment of a bridge in a bridge circuit according to the disclosure,

FIG. 7h shows an eighth embodiment of a bridge in a bridge circuit according to the disclosure,

FIG. 7i shows a ninth embodiment of a bridge in a bridge circuit according to the disclosure,

FIG. 7j shows a tenth embodiment of a bridge in a bridge circuit according to the disclosure, and

FIG. 7k shows an eleventh embodiment of a bridge in a bridge circuit according to the disclosure.

### DETAILED DESCRIPTION

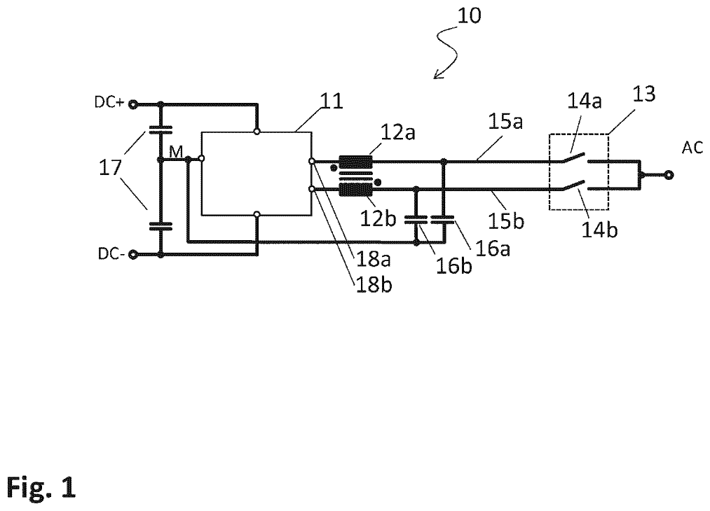

FIG. 1 shows an embodiment of a bridge circuit 10 according to the disclosure with direct current terminals DC+, DC−, to which a direct current source or direct current load can be connected. Between the direct current terminals DC+, DC−, an intermediate circuit in the form of a series connection of two intermediate circuit capacitors 17 is arranged, the centre point M of which, together with the direct current terminals DC+, DC−, provide DC voltages of a bridge 11. The bridge 11 comprises two bridge outputs 18a, 18b, at which the bridge 11 provides voltages which are formed from the DC voltages and are clocked independently of one another.

A first connection path 15a extends from the first bridge output 18a to a phase terminal AC of the bridge circuit 10, in which a first filter choke 12a is arranged on the bridge output side, and a relay contact 14a of a disconnector 13 is arranged on the phase terminal side. Between the first filter choke 12a and the disconnector 13, a first filter capacitor 16a branches off, and is connected to the centre point M. The second connection path 15b is constructed analogously and extends from the bridge output 18b to the phase terminal AC of the bridge circuit 10, in which a second filter choke 12b is arranged on the bridge output side, and a further relay contact 14b of the disconnector 13 is arranged on the phase terminal side. Between the second filter choke 12b and the disconnector 13, a second filter capacitor 16b branches off, and is also connected to the centre point M. The filter capacitors 16a, 16b can alternatively be connected to one of the direct current terminals DC+, DC−.

In one embodiment, the first filter choke 12a and the second filter choke 12b are magnetically coupled to one another; for example, they have a common core. Since a relay contact 14a, 14b is arranged in each of the connection paths 15a, 15b, the disconnector 13 can be configured with regard to its current carrying capacity for the maximum current that can flow in the respective connection path 15a, 15b. This allows the disconnector 13 to be designed cost-effectively. However, it is also conceivable in one embodiment that each of the relay contacts 14a, 14b be formed by two serial contacts which can be actuated separately from one another for safety reasons, for example, by being assigned to different relays. However, as already mentioned above, a single relay contact in each connection path can also meet applicable safety standards, for example, if a galvanically isolating plane is connected upstream or downstream of the bridge circuit. This also applies to the embodiments described below.

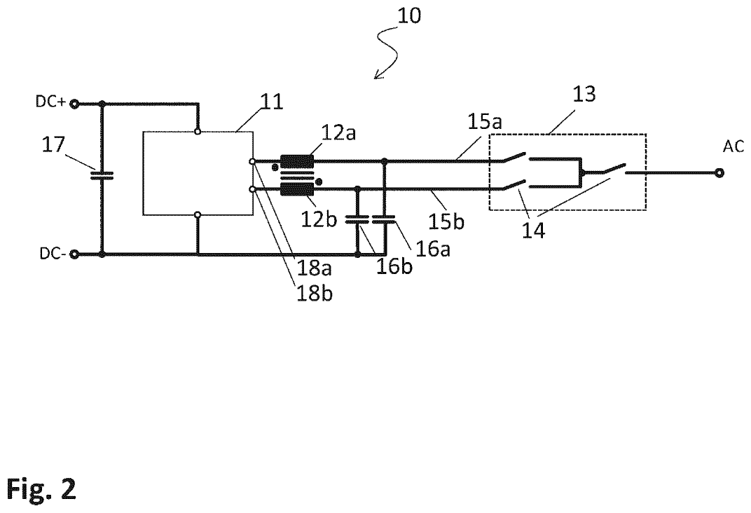

The bridge circuit 10 embodiment shown in FIG. 2 differs from the circuit shown in FIG. 1 in that the disconnector 13 now comprises three relay contacts 14, of which one relay contact is arranged in a common portion of the connection paths 15a, 15b, while the other relay contacts 14 are each arranged in portions of the connection paths 15a, 15b that run separately from one another. As a result, in one embodiment the relay contact 14 arranged in the common portion of the connection paths 15a, 15b is configured for the maximum current at the phase terminal AC, which enables only part of the savings. At the same time, however, this arrangement of the relay contacts 14 makes it possible to detect an electrical variable, for example, the voltage, between the serial arrangement of the relay contacts 14 with the same measuring device, so that a measuring device can be dispensed with if desired or necessary. This detection may be desired or necessary during a functional test of the relay contacts, during a synchronization process of the alternating voltage provided by the bridge circuit before connection to an AC voltage grid connected to the phase terminal, or during normal feed-in operation of the bridge circuit.

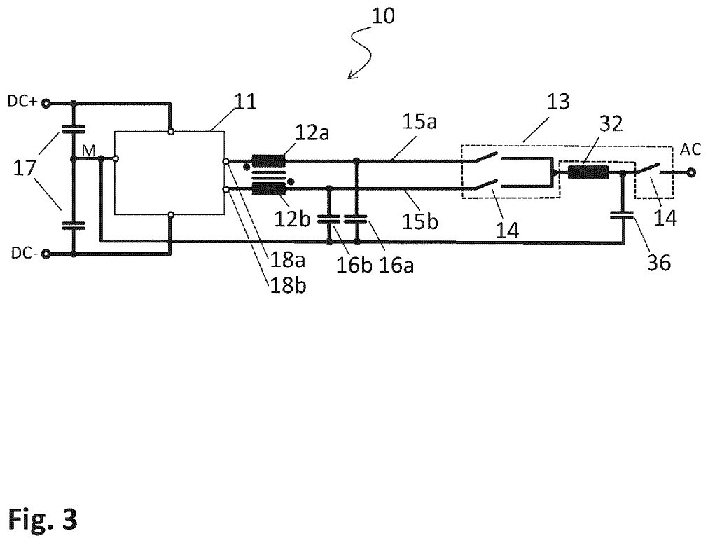

The bridge circuit 10 embodiment of FIG. 3 has the same arrangement of the relay contacts 14 as shown in FIG. 2, wherein, additionally, a further filter is arranged in the common portion of the connection paths 15a, 15b between the serial relay contacts 14. The further filter comprises another filter choke 32 and another filter capacitor 36, which is also connected to the centre point M.

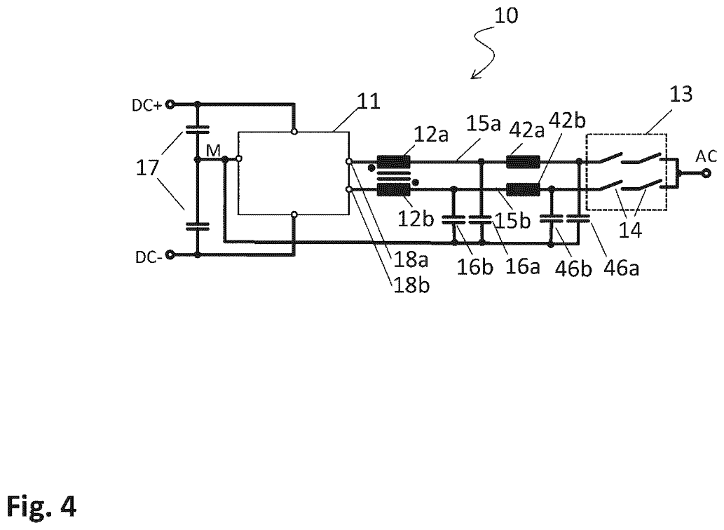

The bridge circuit 10 embodiment of FIG. 4 again takes up the arrangement of the relay contacts 14 as shown in FIG. 1, wherein, in addition, in each of the connection paths 15a, 15b, a second filter is arranged between the magnetically coupled filter chokes 12a, 12b and the disconnector 13. In the first connection path 15a, the second filter is formed by a second filter choke 42a and a second filter capacitor 46a. In the second connection path 15b, the second filter is formed by a second filter choke 42b and a second filter capacitor 46b. The second filter chokes 42a, 42b of the first connection path 15a and of the second connection path 15b are shown here as not magnetically coupled, but they can also be magnetically coupled to one another in another embodiment. The additional filters effectively suppress non-mains frequency components of the alternating current provided by the bridge circuit 10. The connection of the filter capacitors 46a and 46b to the centre point M can be omitted in one embodiment, for example, when using the bridge circuit in three-phase inverters or rectifiers.

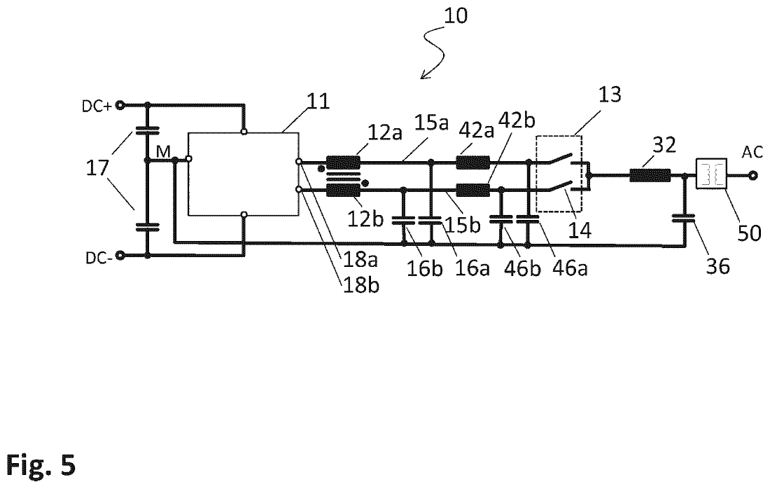

As shown in the embodiment of FIG. 5, starting from the design of the bridge circuit 10 from FIG. 3, the second filters with the second filter chokes 42a, 42b and the second filter capacitors 46a, 46b in each of the connection paths 15a, 15b can also be combined with the further filter having the further filter choke 32 and the further filter capacitor 36, in order to further enhance a filtering effect of the non-mains frequency components of the alternating current provided.

In addition, a galvanic isolation plane 50 is shown in the embodiment of FIG. 5, which here is, for example, a transformer arranged in the common portion of the first connection path and of the second connection path. This makes it possible to meet any safety requirements regarding the isolation from a connected network without having to provide two serial, independently actuatable relay contacts of the disconnector 13 in each of the connection paths. Instead, a single relay contact 14 in each of the connection paths 15a, 15b is sufficient. Instead of an AC-side arrangement of the galvanic isolation plane 50, in one embodiment a DC− side arrangement, for example, by means of a galvanically isolating DC/DC converter (not shown) connected upstream of the bridge circuit 10, can also meet the safety requirements without serial relay contacts. In the same way, the other embodiments can also be configured to be safety-compliant by providing a galvanic isolation plane 50 with a single relay contact in each of the connection paths 15a, 15b. One example in which galvanic isolation between the mains and direct current terminals is sometimes required even when the disconnector is closed is DC charging devices, for example, for electric vehicles. In this case, a single relay contact 14 in each of the connection paths 15a, 15b is sufficient to meet the safety requirements.

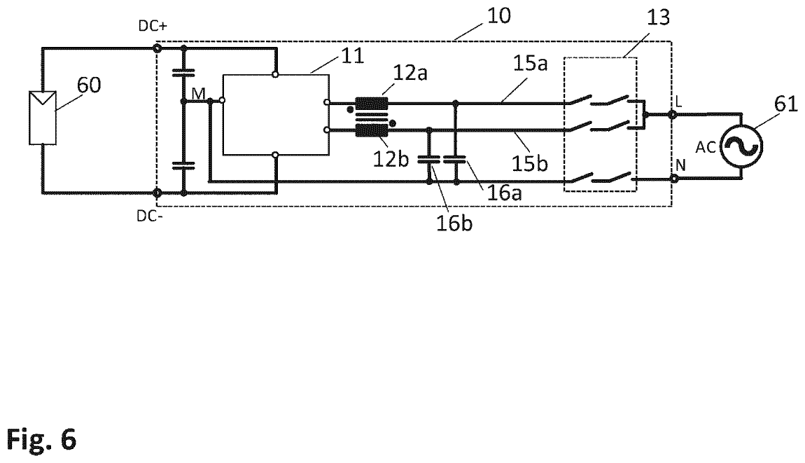

In one embodiment FIG. 6 shows an energy conversion system based on a bridge circuit 10 according to the disclosure for single-phase feeding of alternating current into an AC voltage grid 61 connected to the energy conversion system. The structure of the bridge circuit 10 corresponds to the embodiment shown in FIG. 1, but it can also be configured in accordance with the other embodiments of a bridge circuit according to the disclosure. A generator 60 of the energy conversion system, for example, a photovoltaic generator, is connected to the direct current terminals DC+, DC− of the bridge circuit 10 in one embodiment. The phase terminal of the bridge circuit 10 is connected to the phase conductor L of the AC voltage grid 61. The neutral conductor N of the AC voltage grid is also connected to the center point M of the bridge circuit 10 via two serial relay contacts of the disconnector 13.

Multi-phase feeding of alternating current into an AC voltage grid can also be easily implemented with the aid of bridge circuits in another embodiment, in that a bridge circuit 10 according to the disclosure is assigned to each phase of the AC voltage grid and is connected by its phase terminal to the respective phase conductor of the AC voltage grid. The direct current terminals DC+, DC− are usually connected in parallel, but it is also possible to connect separate generators to the respective bridge circuits.

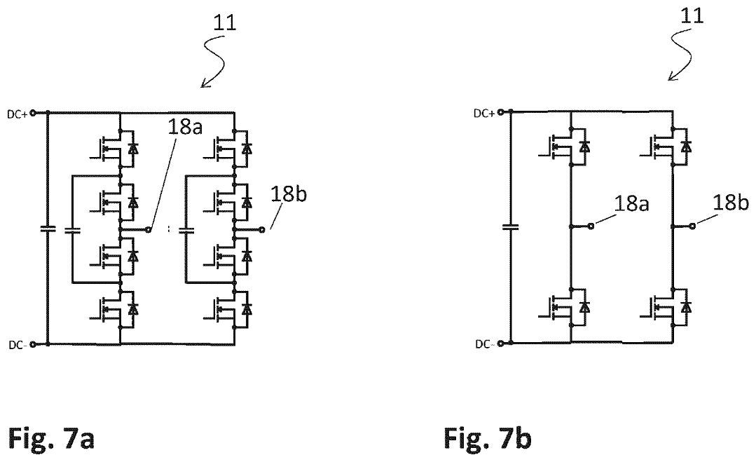

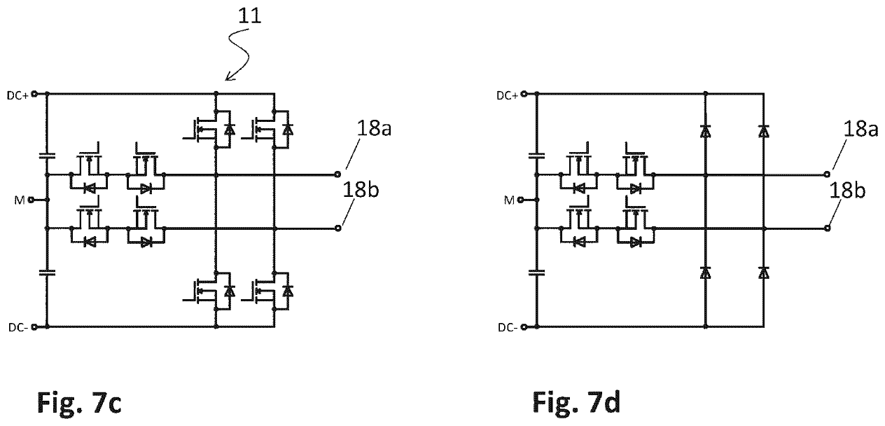

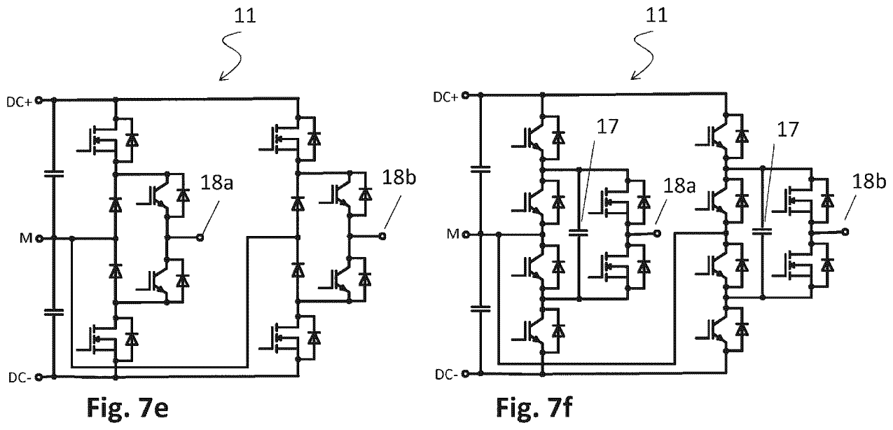

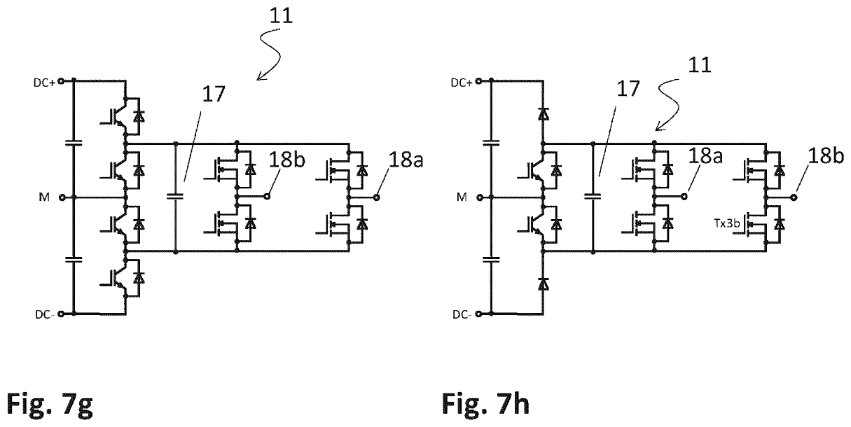

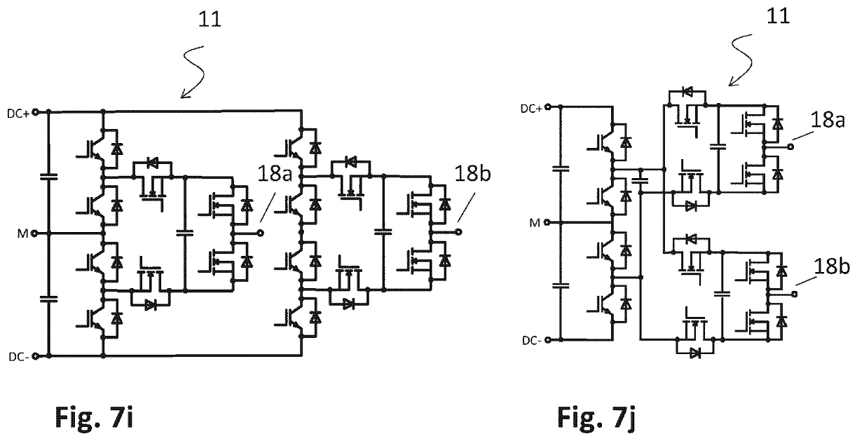

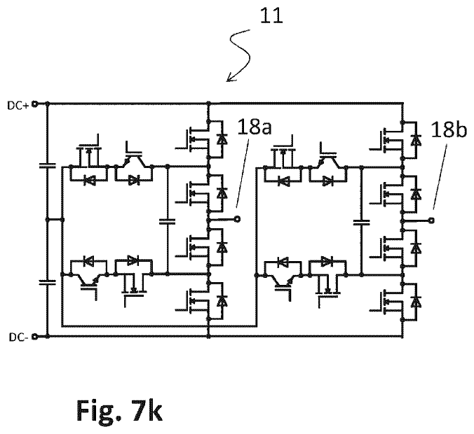

In FIG. 7a to FIG. 7k, conceivable switch arrangements of bridges are shown in a non-exhaustive list and in no particular order of priority, as they can be used in a bridge circuit according to various embodiments of the disclosure.

The switch arrangement in FIG. 7a shows two parallel connected, so-called “flying capacitor” half-bridges in which, in addition to the potentials of the direct current terminals DC+, DC−, a third potential shifted by the capacitor voltage can be provided at the bridge outputs 18a, 18b independently of one another via a capacitor arranged within the bridge.

However, it is also conceivable, as shown in the embodiment of FIG. 7b, to arrange two simple half-bridges, each with two switches, in parallel between the direct current terminals DC+, DC− and to connect the bridge output 18a, 18b of the two half-bridges to the phase terminal via one of the connection paths. The switch arrangements in FIG. 7a and FIG. 7b do not require a divided intermediate circuit, and therefore do not require a connection to a center point thereof.

In contrast, the switch arrangements of the embodiments FIG. 7c to FIG. 7k have terminals at a center point M of the intermediate circuit configured as a divided intermediate circuit, so that, at the bridge outputs 18a, 18b, at least three different potentials can be provided in a clocked manner with the potentials of the direct voltage terminals DC+, DC− and the center point M.

FIG. 7c is an embodiment that shows two so-called BSNPC (bipolar switched neutral point clamped) bridges connected in parallel, which can also be used and also require a connection to a center point of a divided intermediate circuit. If the switches connected to the direct current terminals DC+, DC− are replaced by diodes, as shown in the embodiment of FIG. 7d, the bridge circuit can still be used as a rectifier to supply a direct current load.

FIG. 7e is an embodiment that shows two so-called NPC bridges (neutral point clamped bridges) connected in parallel, which can also be used and also require a connection to a center point of a divided intermediate circuit.

FIG. 7f is an embodiment that shows two so-called ANPC bridges (active neutral point clamped bridges) connected in parallel, which can also be used and also require a connection to a center point of a divided intermediate circuit. The capacitor 17 is optional and can be omitted if the clocking method is changed.

FIG. 7g is an embodiment that shows another bridge circuit that can also be used and also requires a connection to a center point of a divided intermediate circuit. If the switches connected to the direct current terminals DC+, DC− are replaced by diodes, as shown in the embodiment of FIG. 7h, the bridge circuit can still be used as a rectifier to supply a direct current load. Here, too, capacitor 17 is optional and can be omitted if a suitable clocking method is used.

FIGS. 7i, 7j, and 7k are various embodiments that show three further bridge circuits that can also be used and also require a connection to a center point of a divided intermediate circuit. In contrast to the circuits in FIGS. 7a to 7h, here, five potentials can be provided at the bridge output 18a and 18b.

Regardless of the switch types shown in FIG. 7a to FIG. 7k, either an IGBT, MOSFET, both, for example, silicon or silicon carbide switches, HEMT or GIT switches, or both gallium nitride switches, can generally be used at any position for the bridge circuit. Other self-locking switch types are also conceivable for use within the bridges in various embodiments.

What is claimed is:

1. A bridge circuit for providing an alternating current at a phase terminal, comprising:
a first direct current terminal and a second direct current terminal configured to be connected to a direct current source or direct current load,
an intermediate circuit connected between the first direct current terminal and the second direct current terminal,
a bridge comprising bridge switches, wherein the bridge is configured to receive voltage potentials at the first direct current terminal and the second direct current terminal and provide voltage potentials at a first bridge output and a second bridge output thereof, wherein the voltage potentials at the first bridge output and the second bridge output are generated by independent clocking of corresponding bridge switches,
a first connection path extending between the first bridge output and the phase terminal, and a second connection path extending between the second bridge output and the phase terminal, wherein the first and second connection paths comprise a separated portion where both the first and second connection paths are separate from one another, and a common portion where the first and second connection paths share a same connection path,
wherein each of the first and second connection paths comprise, on a bridge output side thereof, a respective first and second filter choke, and wherein the first and second filter chokes of the first and second connection paths are magnetically coupled to one another,
a disconnector device comprising a plurality of relay contacts arranged on the first and second connection paths between the first and second bridge outputs, respectively, and the phase terminal wherein at least one of the relay contacts is arranged in the separated portion of each of the first and second connection paths.

2. The bridge circuit according to claim 1, wherein the bridge is configured to provide at each of the first and second bridge outputs three voltage potential levels formed from voltage potentials received at the first and second direct current terminals.

3. The bridge circuit according to claim 1, wherein the bridge is configured to provide at each of the first and second bridge outputs five voltage potential levels formed from voltage potentials received at the first and second direct current terminals.

4. The bridge circuit according to claim 1, wherein the disconnector device comprises two independently actuatable relay contacts arranged in series in the first and second connection paths, respectively, between each of the first and second bridge outputs and the phase terminal.

5. The bridge circuit according to claim 1, wherein, in the separated portion of the first and second connection paths, two serial relay contacts of the disconnector device are arranged in each of the first and second connection paths.

6. The bridge circuit according to claim 1, wherein the intermediate circuit comprises a divided intermediate circuit comprising a center point, and wherein the bridge is configured to receive voltage potentials at the first direct current terminal, the second direct current terminal, and the center point, and provide voltage potentials at the first bridge output and the second bridge output in a clocked manner independently of one another in response to the received voltage potentials.

7. The bridge circuit according to claim 6, further comprising, in each of the first and second connection paths, a respective filter capacitor connected between a respective filter choke and the disconnector device, wherein each filter capacitor is connected by a further terminal to the first direct current terminal, the second direct current terminal, or the center point.

8. The bridge circuit according to claim 1, further comprising, in at least one of the first and second connection paths, a second filter, comprising another filter choke and a second filter capacitor arranged between the respective first or second filter choke and the disconnector device.

9. The bridge circuit according to claim 1, wherein the first and second connections paths each comprise a separate portion and a common portion, and wherein the plurality of relay contacts comprises a common relay contact of the disconnector device arranged in the common portion of the first connection path and of the second connection path.

10. The bridge circuit according to claim 9, further comprising a further filter comprising a further filter choke and a further filter capacitor arranged in the common portion of the first connection path and of the second connection path, wherein the common relay contact of the disconnector device is arranged between the further filter and the phase terminal.

11. An energy conversion system comprising a bridge circuit for providing an alternating current at a phase terminal, comprising:
a first direct current terminal and a second direct current terminal configured to be connected to a direct current source or direct current load,
an intermediate circuit connected between the first direct current terminal and the second direct current terminal,
a bridge comprising bridge switches, wherein the bridge is configured to receive voltage potentials at the first direct current terminal and the second direct current terminal and provide voltage potentials at a first bridge output and a second bridge output thereof, wherein the voltage potentials at the first bridge output and the second bridge output are generated by independent clocking of corresponding bridge switches,
a first connection path extending between the first bridge output and the phase terminal, and a second connection path extending between the second bridge output and the phase terminal, wherein the first and second connection paths comprise a separated portion where both the first and second connection paths are separate from one another, and a common portion where the first and second connection paths share a same connection path,
wherein each of the first and second connection paths comprise, on a bridge output side thereof, a respective first and second filter choke, and wherein the first and second filter chokes of the first and second connection paths are magnetically coupled to one another,
a disconnector device comprising a plurality of relay contacts arranged on the first and second connection paths between the first and second bridge outputs, respectively, and the phase terminal, wherein at least one of the relay contacts is arranged in the separated portion of each of the first and second connection paths.
